(19) United States
(12) Patent Application Publication
(10) Pub. No.: US 2026/0370080 A1
(43) Pub. Date: Nov. 19, 2026

(54) ELECTRIC DRIVE UNIT HAVING A MAIN SUPPLY CHANNEL

(71) Applicant: BorgWarner Inc., Auburn Hills, MI (US)

(72) Inventors: Christopher Anthony Chirco, Romeo, MI (US); Aniruddha Chavan, Rochester Hills, MI (US); Qingyuan Zha, Novi, MI (US); Dileep Kumar Rangapura Shivakumara, Karnataka (IN)

(21) Appl. No.: 19/671,031

(22) Filed: May 7, 2026

Related U.S. Application Data
(60) Provisional application No. 63/882,518, filed on Sep. 16, 2025.
(60) Provisional application No. 63/806,435, filed on May 15, 2025.

(51) Int. Cl. H02K 5/20; H02K 7/00; H02K 7/116; H02K 9/193

(52) U.S. Cl. CPC H02K 5/203; H02K 7/003; H02K 7/116; H02K 9/193

(57) ABSTRACT

An electric drive unit includes a housing assembly including a main housing body extending along a first axis. The main housing body defines a housing interior and includes a divider wall that subdivides the housing interior into first and second chambers. An electric machine is disposed in the first chamber. A differential assembly is disposed in the second chamber. A reduction gearset is coupled to the electric machine and the differential assembly for transmitting torque therebetween. The main housing body further defines a main supply channel spaced radially from the first axis and extending parallel to the first axis for receiving fluid for distribution to the housing interior, and a plurality of distribution channels including a first distribution channel extending between the main supply channel and the first chamber and a second distribution channel extending between the main supply channel and the second chamber.

### CROSS-REFERENCE TO RELATED APPLICATIONS

The present application claims priority to and all the benefits of U.S. Provisional Patent Application Nos. 63/806,435 filed on May 15, 2025, and 63/882,518 filed Sep. 16, 2025, which are hereby expressly incorporated herein by reference in their entirety.

### BACKGROUND OF THE INVENTION

### 1. Field of the Invention

The present disclosure relates generally to an electric drive unit having a main supply channel.

### 2. Description of Related Art

Electric drive units often package rotating components, such as an electric machine, a reduction gearset, and a differential assembly, within a housing interior of a housing assembly. During operation of the electric drive unit, the rotating components and other internal componentry of the electric drive unit require a supply of fluid for cooling and/or lubrication. In compact electric drive units, there are challenges in designing fluid supply passages and associated distribution paths due to packaging constraints, such as the limited envelope available for disposing the electric drive unit within the vehicle and/or the installation orientation of the electric drive unit relative to the vehicle. Accordingly, there remains a need for an improved electric drive unit having a main supply channel for supplying fluid to the internal componentry of the electric drive unit.

### SUMMARY AND ADVANTAGES

The present disclosure is generally directed to an electric drive unit including a housing assembly. The housing assembly includes a main housing body extending along a first axis between a first end and a second end spaced from the first end in a first direction along the first axis. The main housing body defines a housing interior about the first axis and includes a divider wall that subdivides the housing interior into a first chamber extending along the first axis and delimited by the divider wall in the first direction, and a second chamber extending along the first axis delimited by the divider wall in a second direction opposite the first direction. The electric drive unit also includes an electric machine disposed in the first chamber and a differential assembly disposed in the second chamber. The electric drive unit further includes a reduction gearset coupled to the electric machine and the differential assembly for transmitting torque between the electric machine and the differential assembly. The main housing body further defines a main supply channel spaced radially from the first axis and extending parallel to the first axis. The main supply channel is configured to receive fluid for distribution to the housing interior. The main housing body additionally defines a plurality of distribution channels. The plurality of distribution channels includes a first distribution channel extending between the main supply channel and the first chamber to arrange the main supply channel in fluid communication with the first chamber for directing the fluid from the main supply channel into the first chamber, and a second distribution channel extending between the main supply channel and the second chamber to arrange the main supply channel in fluid communication with the second chamber for directing the fluid from the main supply channel into the second chamber.

Advantageously, the main supply channel serves as a common supply passage from which the plurality of distribution channels extend to direct the fluid to desired locations within the housing interior. This architecture provides significant design flexibility within the tight packaging constraints typically associated with electric drive units, as distribution channels can be defined anywhere along the main supply channel to direct fluid to locations within the housing interior as needed based on the application.

### BRIEF DESCRIPTION OF THE DRAWINGS

Other advantages of the present disclosure will be readily appreciated, as the same becomes better understood by reference to the following detailed description when considered in connection with the accompanying drawings.

FIG. 1 is a perspective view of the electric drive unit according to the present disclosure illustrating a feeding path and a main supply channel in phantom.

FIG. 2A is an exploded view of the electric drive unit of FIG. 1 from a first perspective.

FIG. 2B is another exploded view of the electric drive unit of FIG. 1 from a second perspective.

FIG. 3 is a side view of the electric drive unit.

FIG. 4 is a cross-sectional representation of the electric drive unit taken through line 4-4 of FIG. 3.

FIG. 5 is a cross-sectional representation taken along line 5-5 of FIG. 4 to reveal the componentry of a differential assembly of the electric drive unit.

FIG. 6 is a cross-sectional representation taken along line 6-6 of FIG. 4 to reveal the componentry of a second planetary gearset of the reduction gearset of the electric drive unit.

FIG. 7 is a cross-sectional representation taken along line 7-7 of FIG. 4 to reveal the componentry of a first planetary gearset of the reduction gearset of the electric drive unit.

FIG. 8 is a cross-sectional representation taken along line 8-8 of FIG. 4 to reveal the componentry of an electric machine of the electric drive unit.

FIG. 9 is a cross-sectional representation taken along line 9-9 of FIG. 3 to reveal a main supply channel and a plurality of distribution channels of the electric drive unit.

FIG. 10 is a detail view of FIG. 9 illustrating distribution channels extending from the main supply channel to the second chamber.

FIG. 11 is a detail view of FIG. 9 illustrating a distribution channel extending from the main supply channel to a central void of a divider wall of the housing assembly.

FIG. 12 is a detail view of FIG. 9 illustrating distribution channels extending from the main supply channel to the first chamber.

FIG. 13 is a detail view of FIG. 9 illustrating a cover distribution channel in fluid communication with the main supply channel and extending through a first end cover to a first end cover void.

### DETAILED DESCRIPTION OF THE INVENTION

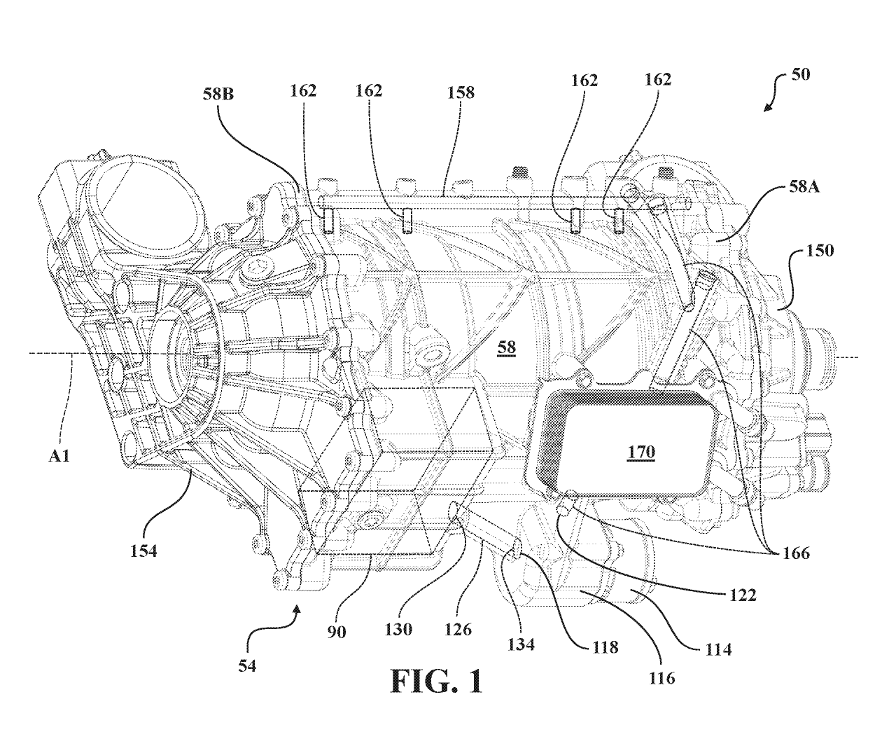

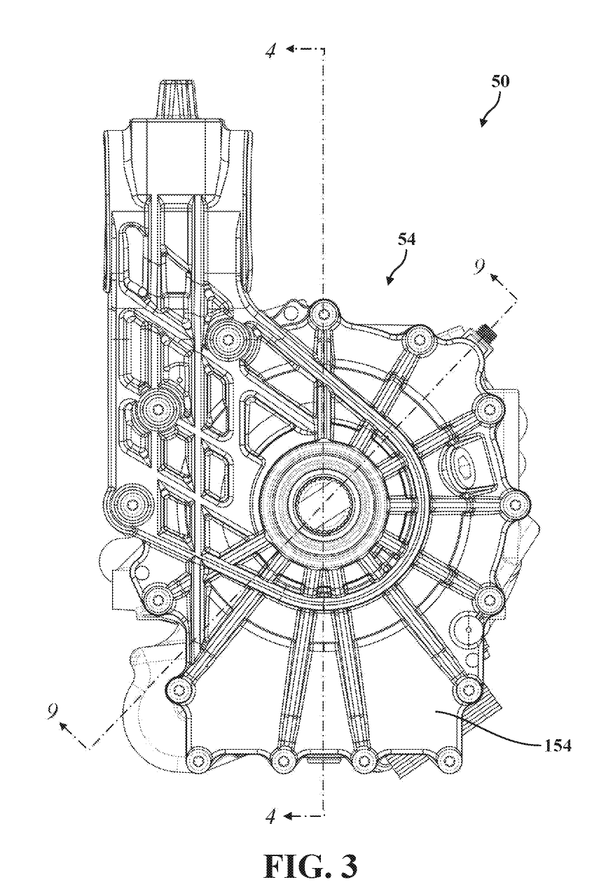

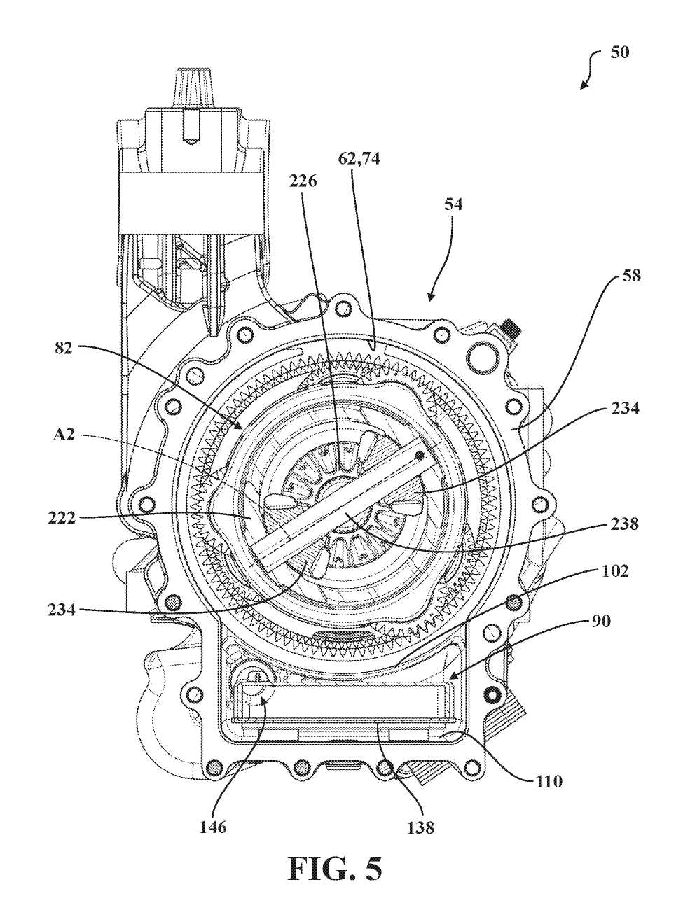

Referring to the drawings, wherein like reference numerals are used to identify like or identical components in the various views, FIGS. 1-13 illustrate an electric drive unit 50 according to the present disclosure. The electric drive unit 50 according to the present disclosure is generally configured for use in an electrified vehicle for providing propulsion torque and/or for receiving regenerative braking torque. While the electric drive unit 50 according to the present disclosure is described in the context of automotive applications, other vehicle applications employing the electric drive unit 50 are also contemplated including, but not limited to, heavy duty trucks, agricultural vehicles, construction vehicles, and recreational vehicles.

Referring to FIG. 1, the electric drive unit 50 includes a housing assembly 54. The housing assembly 54 includes a main housing body 58 extending along a first axis A1 between a first end 58A and a second end 58B spaced from the first end 58A in a first direction D1 along the first axis A1. The main housing body 58 defines a housing interior 62 about the first axis A1 within which the internal componentry of the electric drive unit 50 is disposed, as described in further detail below. The main housing body 58 includes a divider wall 66 that subdivides the housing interior 62 into a first chamber 70 and a second chamber 74 extending along the first axis A1. The first chamber 70 is delimited by the divider wall 66 in the first direction D1. The second chamber 74 is delimited by the divider wall 66 in a second direction D2 opposite the first direction D1. The electric drive unit 50 further includes various components which rotate in the housing interior 62 including an electric machine 78 disposed in the first chamber 70, a differential assembly 82 disposed in the second chamber 74, and a reduction gearset 86 coupled to the electric machine 78 and the differential assembly 82 for transmitting torque between the electric machine 78 and the differential assembly 82. Exemplary configurations of the electric machine 78, the differential assembly 82, and the reduction gearset 86 are shown throughout the FIGS. and described in further detail below.

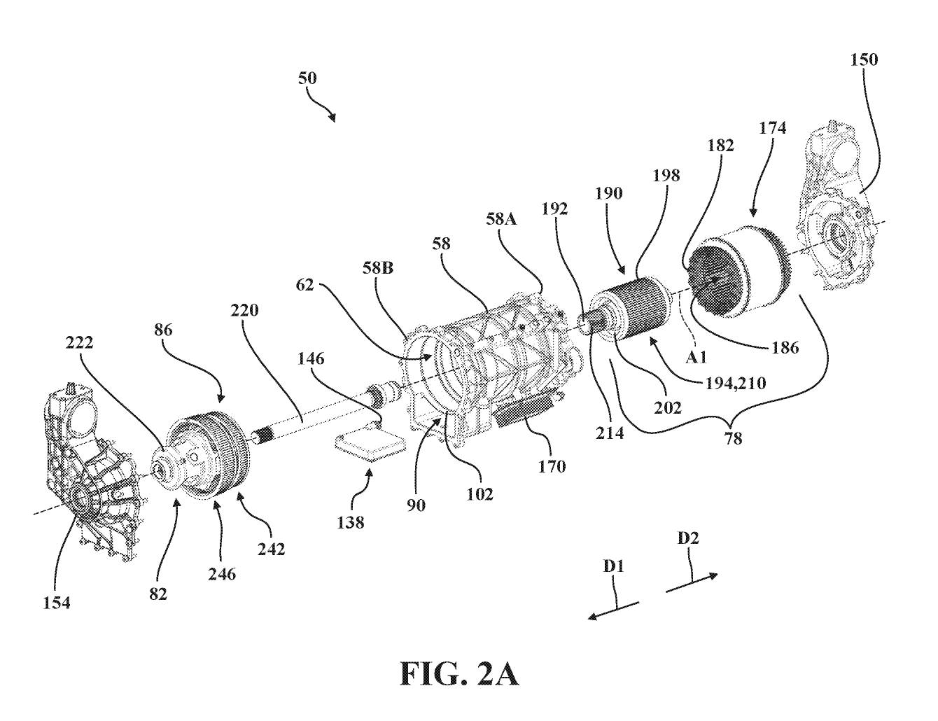

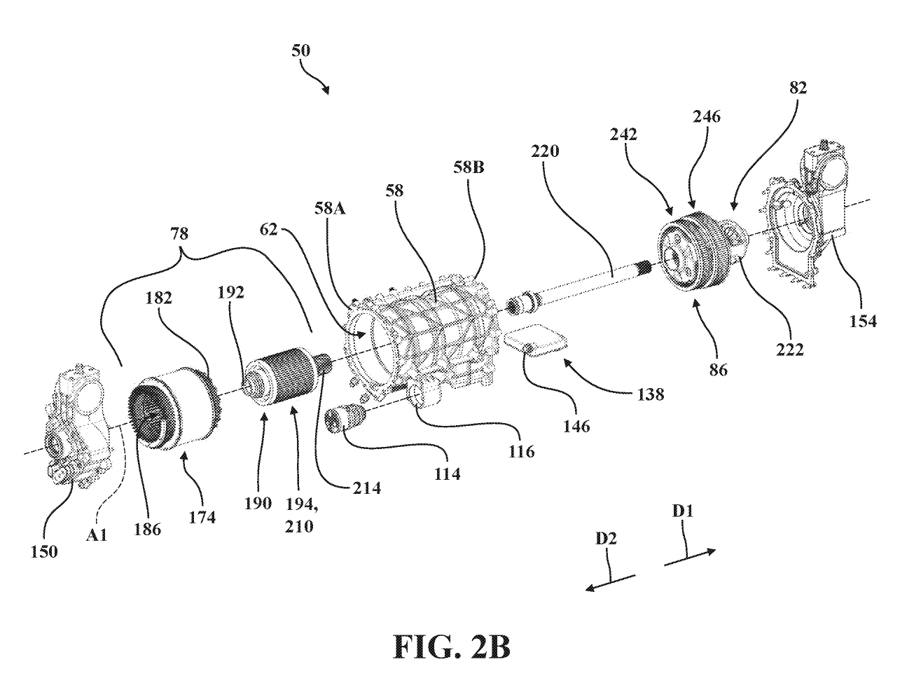

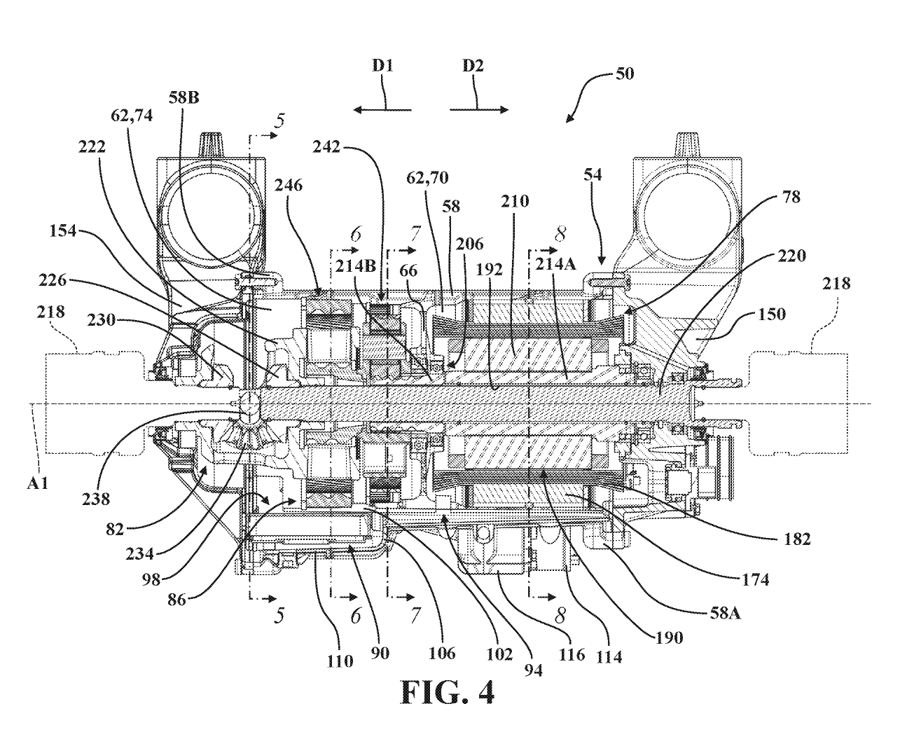

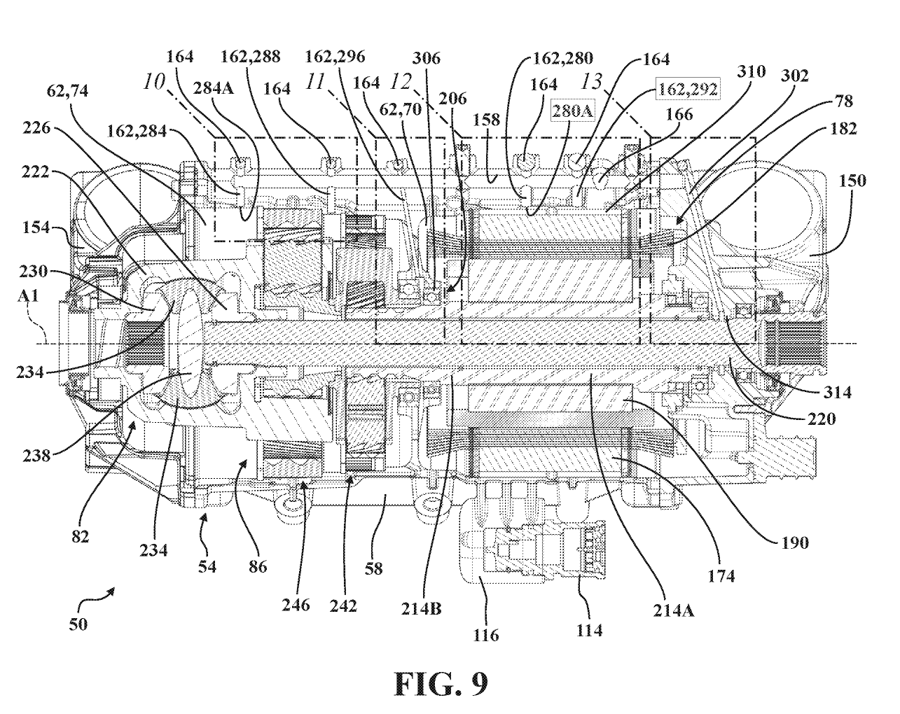

The electric drive unit 50 is generally configured facilitate circulation of the fluid throughout the housing interior 62 to cool and/or lubricate the internal componentry disposed in the housing interior 62. The fluid may be any cooling and/or lubrication fluid suitable for the application, such as oil. As best shown in FIGS. 9-13, to supply the fluid to the internal componentry disposed in the housing interior 62, the main housing body 58 further defines a main supply channel 158 (described in further detail below) configured to receive fluid for distribution to the housing interior 62 and a plurality of distribution channels 162 (also described in further detail below) for directing the fluid from the main supply channel 158 into the housing interior 62. As best shown in FIGS. 2A, 2B and 4, the main housing body 58 typically further defines a fluid sump 90 in fluid communication with the housing interior 62 for collecting the fluid from the housing interior 62 for recirculation through the housing interior 62. In these configurations, the electric drive unit 50 typically further includes a fluid pump 114 in communication with the fluid sump 90 and the main supply channel 158 for directing the fluid from the fluid sump 90 into the main supply channel 158. The fluid pump 114 can be internal or external to the housing assembly 54. In the illustrated configuration, referring to FIG. 2B, the main housing body 58 defines a pump receptacle 116 configured to at least partially receive the fluid pump 114 to couple the fluid pump 114 to the main housing body 58 and arrange the fluid pump 114 in fluid communication with the fluid sump 90 and main supply channel 158. Other configurations of coupling the fluid pump 114 to the main housing body 58 are contemplated without departing from the scope of the present disclosure.

As best shown in FIG. 1, to arrange the fluid pump 114 in fluid communication with the fluid sump 90, the main housing body 58 may also define a fluid passage 126 extending between the fluid sump 90 and the fluid pump 114. As also shown in FIG. 1, the main housing body 58 may further define a fluid feeding path 166 in fluid communication with the fluid pump 114 and the main supply channel 158 for directing the fluid from the fluid pump 114 to the main supply channel 158. Stated differently, in these configurations, the fluid pump 114 draws the fluid from the fluid sump 90 via the fluid passage 126 and delivers the fluid to the main supply channel 158 via the fluid feeding path 166 for distribution through the plurality of distribution channels 162 to the housing interior 62. The fluid thereafter returns from the housing interior 62 to the fluid sump 90 for recirculation. Other configurations for supplying the fluid to the main supply channel 158 are contemplated. In some examples, the electric drive unit 50 further includes a heat exchanger 170 disposed in fluid communication along the fluid feeding path 166 extending between the fluid pump 114 and the main supply channel 158 so that the fluid driven from the fluid pump 114 can be conditioned (i.e., either cooled or heated) before entering the main supply channel 158.

As best shown in FIG. 4, in some configurations, the fluid sump 90 is spaced radially outward relative to the first axis A1 from the first chamber 70 and the second chamber 74. For example, the main housing body 58 may include a radial extension 106 and a lower sump wall 110 extending axially relative to the radial extension 106 to define the fluid sump 90. In these configurations, the main housing body 58 further defines a first drain path 94 extending between the first chamber 70 and the fluid sump 90 to arrange the first chamber 70 in fluid communication with the fluid sump 90 for returning the fluid from the first chamber 70 to the fluid sump 90, and a second drain path 98 extending between the second chamber 74 and the fluid sump 90 to arrange the second chamber 74 in fluid communication with the fluid sump 90 for returning the fluid from the second chamber 74 to the fluid sump 90. Accordingly, in these configurations, the fluid sump 90 serves as a shared reservoir for collecting the fluid from both the first chamber 70 and the second chamber 74 through the first and second drain paths 94, 98 for recirculation through the housing interior 62 via the fluid pump 114 and the main supply channel 158.

Referring again to FIGS. 9-13, the main supply channel 158 is spaced radially from the first axis A1 and extends parallel to the first axis A1. In the illustrated configuration, the main supply channel 158 is arranged radially outward from the first chamber 70 and the second chamber 74 such that the main supply channel 158 extends axially along an exterior region of the main housing body 58 that is radially offset from the rotating componentry of the electric drive unit 50; however, other configurations are contemplated. The main supply channel 158 may be machined or otherwise formed in the main housing body 58. The plurality of distribution channels 162 extend between the main supply channel 158 and selected regions of the housing interior 62 to arrange the main supply channel 158 in fluid communication with the first chamber 70, the second chamber 74, and/or other fluid-receiving portions of the electric drive unit 50. The plurality of distribution channels 162 may be machined or otherwise formed in the main housing body 58. In the illustrated configuration, the plurality of distribution channels 162 are machined through the main housing body 58, and plugs 164 are disposed in the respective machining holes to delimit the plurality of distribution channels 162 in a radial direction away from the first axis A1. Other approaches for forming the plurality of distribution channels 162 are contemplated.

With continued reference to FIGS. 9-13, the plurality of distribution channels 162 includes a first distribution channel 280 extending between the main supply channel 158 and the first chamber 70 to arrange the main supply channel 158 in fluid communication with the first chamber 70 for directing the fluid from the main supply channel 158 into the first chamber 70. The plurality of distribution channels 162 further includes a second distribution channel 284 extending between the main supply channel 158 and the second chamber 74 to arrange the main supply channel 158 in fluid communication with the second chamber 74 for directing the fluid from the main supply channel 158 into the second chamber 74. Stated differently, the first distribution channel 280 branches from the main supply channel 158 to deliver the fluid to the componentry disposed in the first chamber 70, and the second distribution channel 284 branches from the main supply channel 158 to deliver the fluid to the componentry disposed in the second chamber 74. As described in further detail below, the plurality of distribution channels 162 may include additional distribution channels (e.g. a third distribution channel 288, a fourth distribution channel 292, and/or a fifth distribution channel 296, etc.). Advantageously, the main supply channel 158 serves as a common supply passage from which the plurality of distribution channels 162 extend to direct fluid to desired locations within the housing interior 62. This architecture provides significant design flexibility within the tight packaging constraints typically associated with electric drive units, as distribution channels 162 can be defined anywhere along the main supply channel 158 to direct fluid to locations within the housing interior 62 as needed based on the application. Furthermore, in typical vehicle installations, the electric drive unit 50 is configured to be installed in a vehicle at a predetermined orientation such that main supply channel 158 is arranged above the first axis A1 and the plurality of distribution channels 162 extend downward such that flow of the fluid through the distribution channels is at least partially assisted by gravity, allowing the fluid to flow into the housing interior 62 and on to the rotating internal componentry disposed in the housing interior 62 to cool and/or lubricate the internal componentry.

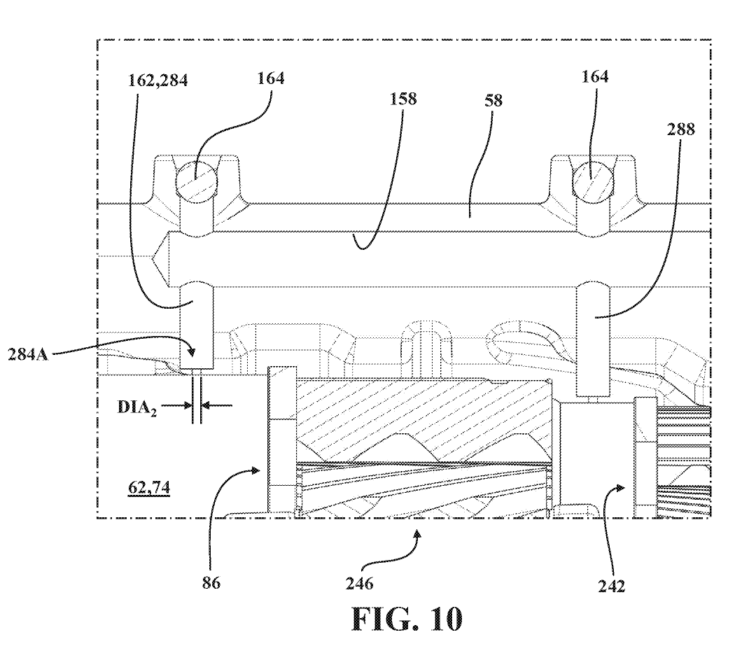

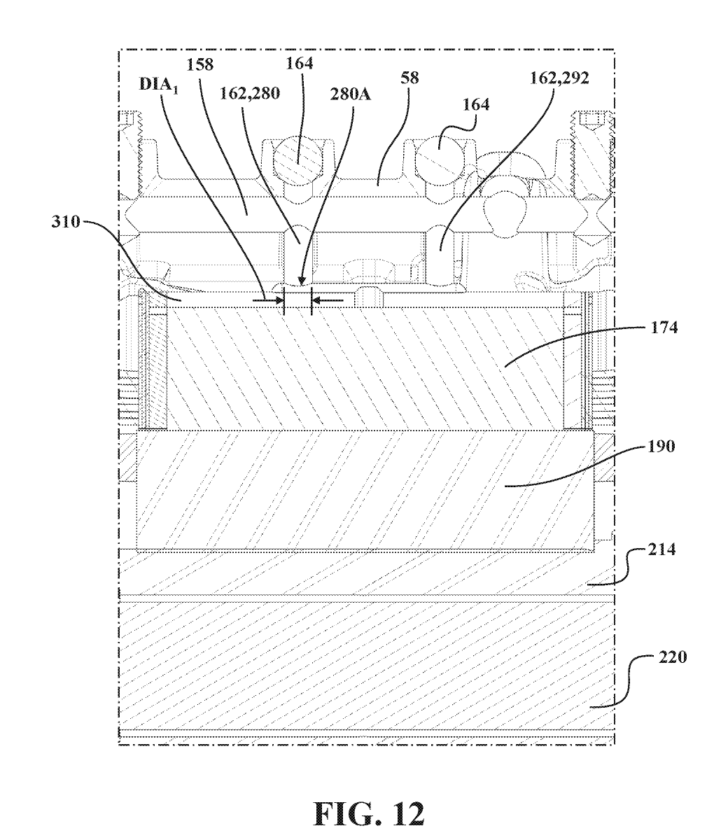

As best shown in FIGS. 10 and 12, in the illustrated configuration, the first distribution channel 280 has a first outlet 280A having a first diameter DIA₁and the second distribution channel 284 has a second outlet 284A having a second diameter DIA₂. In some configurations, the first diameter DIA₁ and the second diameter DIA₂ are different so that the volumetric flow rate of the fluid through the first distribution channel 280 differs from the volumetric flow rate of the fluid through the second distribution channel 284. Accordingly, by appropriately selecting the first diameter DIA₁ and/or the second diameter DIA₂, the respective flowrate of fluid delivered to the first chamber 70 and the second chamber 74 may be implemented based on the respective fluid demands of the internal componentry disposed in the first and second chambers 70, 74. Additionally or alternatively, because the first distribution channel 280 and the second distribution channel 284 both branch from the main supply channel 158, the first diameter DIA₁ and the second diameter DIA₂may be appropriately selected to apportion the fluid from the main supply channel 158 between the first distribution channel 280 and the second distribution channel 284 such that neither of the first distribution channel 280 and the second distribution channel 284 is starved of the fluid by the other. Other configurations where the first diameter DIA₁ and the second diameter DIA₂ are substantially equal are also contemplated. Furthermore, where the plurality of distribution channels 162 includes additional distribution channels (e.g. a third distribution channel 288, a fourth distribution channel 292, and/or a fifth distribution channel 296), the outlet diameters of each of these additional distribution channels may be appropriately selected based on the dynamics described above. Stated differently, the respective distribution channels 162 can be respectively sized and arranged to provide different flow characteristics at different delivery locations within the housing interior 62.

As best shown in FIGS. 9 and 10, in the illustrated configuration, the second distribution channel 284 is aligned with the differential assembly 82 for directing the fluid from the main supply channel 158 toward the differential assembly 82. Stated differently, the second distribution channel 284 may be arranged such that the fluid exiting the second distribution channel 284 is directed toward the differential assembly 82 for lubricating and/or cooling the differential assembly 82. In the illustrated configuration, the second distribution channel 284 extends radially relative to the first axis A1 and is axially aligned with the differential assembly 82 relative to the first axis A1 such that the second outlet 284A of the second distribution channel 284 opens into the second chamber 74 at an axial position along the first axis A1 that generally corresponds to the differential assembly 82. Other arrangements of the second distribution channel 284 relative to the internal componentry disposed in the second chamber 74 are contemplated without departing from the scope of the present disclosure.

With continued reference to FIGS. 9 and 10, as alluded to above, the plurality of distribution channels 162 may further include the third distribution channel 288 spaced axially along the first axis A1 from the second distribution channel 284 and extending between the main supply channel 158 and the second chamber 74 to arrange the main supply channel 158 in fluid communication with the second chamber 74. Where included, the third distribution channel 288 provides an additional fluid communication path from the main supply channel 158 to the second chamber 74 at an axial position along the first axis A1 that is offset from the second distribution channel 284. In the illustrated configuration, the reduction gearset 86 is disposed in the second chamber 74, and the third distribution channel 288 is aligned with the reduction gearset 86 for directing the fluid from the main supply channel 158 toward the reduction gearset 86 for lubricating and/or cooling the reduction gearset 86. Other configurations of the third distribution channel 288 are contemplated without departing from the scope of the present disclosure.

As best shown in FIGS. 9 and 12, the first distribution channel 280 in the illustrated configuration is aligned with the electric machine 78 for directing the fluid from the main supply channel 158 toward the electric machine 78. Stated differently, the first distribution channel 280 may be arranged such that the fluid exiting the first distribution channel 280 is directed toward the electric machine 78 for lubricating and/or cooling the electric machine 78. In the illustrated configuration, the first distribution channel 280 extends radially relative to the first axis A1 and is axially aligned with the electric machine 78 relative to the first axis A1 such that the first outlet 280A of the first distribution channel 280 opens into the first chamber 70 at an axial position along the first axis A1 that generally corresponds to the electric machine 78. Other arrangements of the first distribution channel 280 relative to the internal componentry disposed in the first chamber 70 are contemplated without departing from the scope of the present disclosure

With continued reference to FIGS. 9 and 12, although not required, the plurality of distribution channels 162 may further include the fourth distribution channel 292 spaced axially along the first axis A1 from the first distribution channel 280 and extending between the main supply channel 158 and the first chamber 70 to arrange the main supply channel 158 in fluid communication with the first chamber 70. Stated differently, the fourth distribution channel 292 provides an additional fluid communication path from the main supply channel 158 to the first chamber 70 at an axial position along the first axis A1 offset from the first distribution channel 280. In the illustrated configuration, the fourth distribution channel 292 is also aligned with the electric machine 78 for directing the fluid from the main supply channel 158 toward the electric machine 78; however, other configurations of the fourth distribution channel 292 are contemplated without departing from the scope of the present disclosure.

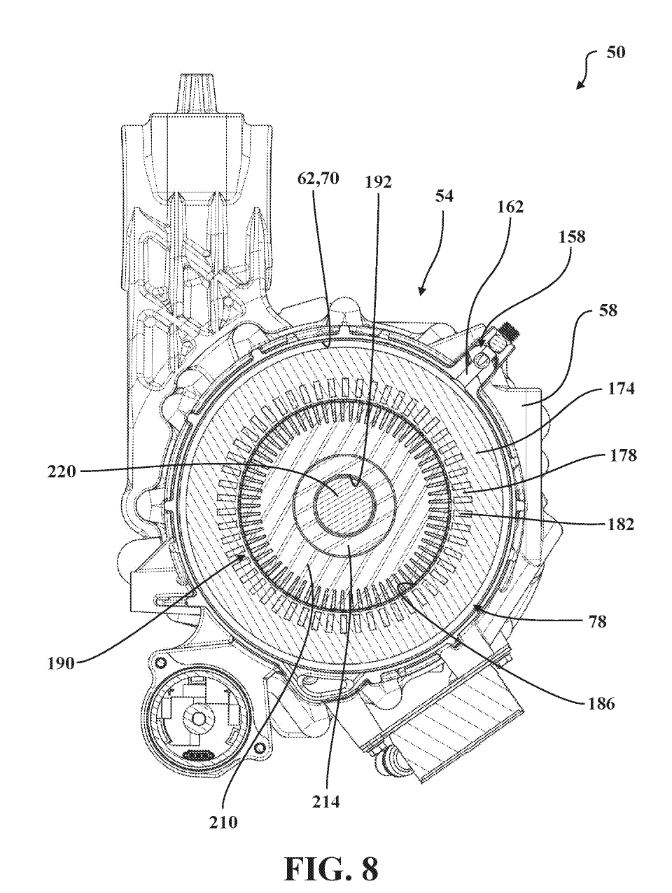

As described above, the electric drive unit 50 includes the electric machine 78. The electric machine 78 is generally configured to generate torque for transfer through the reduction gearset 86 and the differential assembly 82 to propel the vehicle, and may further be configured to receive torque such that the electric machine 78 operates as a generator to regeneratively brake the vehicle. The configuration of the electric machine 78 is not limited for the purposes of this disclosure. Exemplary configurations of the electric machine 78 include permanent magnet synchronous motors, wound-field synchronous motors, switched reluctance motors, synchronous reluctance motors, brushless DC motors, and asynchronous induction motors. As best shown in FIGS. 4 and 8, which represent an asynchronous induction motor configuration, the electric machine 78 includes a stator 174 coupled to the main housing body 58 and disposed annularly about the first axis A1. In the illustrated configuration, the stator 174 includes a stator body 176 comprising a plurality of metallic sheets that are laminated together. The stator body 176 may define stator teeth 178 extending radially inward toward the first axis A1. Stator windings 182 may be disposed between the stator teeth 178. In one implementation, the stator windings 182 can be hairpin stator windings; however, other types of stator windings 182 are contemplated. The stator windings 182 can be coupled to a vehicle battery via an inverter and other power electronics that selectively invert the direct current (DC) electrical power stored in the vehicle battery into alternating current (AC) electrical current, and supply the AC electrical current to the stator windings 182 to energize the stator windings 182.

With continued reference to FIGS. 4 and 8, in the illustrated configuration, the stator 174 defines a stator bore 186 and the electric machine 78 further includes a rotor 190 disposed in the stator bore 186 for rotation relative to the stator 174 about the first axis A1 in response to energization of the stator 174 (e.g. in response to energization of the stator windings 182). In the illustrated asynchronous induction motor configuration, the rotor 190 includes a rotor cage 194 having a plurality of metal bars 198 spaced circumferentially about the first axis A1 and a plurality of metallic sheets 202 that are laminated together and coupled to the plurality of metal bars 198 to cumulatively constitute the rotor 190. Accordingly, in response to energization of the stator windings 182, a magnetic field generated by the stator 174 electromagnetically interacts with the rotor 190 to produce torque on the rotor 190 to rotate the rotor 190 about the first axis A1.

As best shown in FIGS. 8 and 12, in some configurations, to direct the fluid along the stator 174 for cooling of the stator 174, a stator fluid channel 310 for receiving the fluid is defined between an outer circumference of the stator 174 and the main housing body 58. In these configurations, the first distribution channel 280 and/or the fourth distribution channel 292 is/are in fluid communication with the stator fluid channel 310 for subsequently directing the fluid from the main supply channel 158 to the stator fluid channel 310. The stator fluid channel 310 is also typically in fluid communication with the first chamber 70 for directing the fluid to the first chamber 70. Stated differently, the fluid delivered by the first distribution channel 280 and/or the fourth distribution channel 292 first enters the stator fluid channel 310 defined between the outer circumference of the stator 174 and the main housing body 58, travels along the outer circumference of the stator 174 within the stator fluid channel 310 for cooling of the stator 174, and thereafter is directed into the first chamber 70. Other configurations for delivering the fluid to the stator 174 are contemplated without departing from the scope of the present disclosure.

Referring to FIG. 4, in the illustrated configuration, the reduction gearset 86 is disposed in the second chamber 74. In configurations where the reduction gearset 86 is disposed in the second chamber 74, the divider wall 66 may define a central void 206 extending along the first axis A1 between the first chamber 70 and the second chamber 74. In these configurations, the rotor 190 may include a rotor body 210 disposed in the stator bore 186 and a rotor shaft 214 extending along the first axis A1. Here, the rotor shaft 214 includes a first rotor shaft portion 214A coupled to the rotor body 210 such that the rotor shaft 214 rotates with the rotor body 210 about the first axis A1 in response to energization of the stator 174, and a second rotor shaft portion 214B extending from the first rotor shaft portion 214A in the first direction D1 through the central void 206 of the divider wall 66. As best shown in FIG. 4, the second rotor shaft portion 214B is coupled to the reduction gearset 86 to transmit torque between the electric machine 78 and the differential assembly 82. Other configurations of coupling the electric machine 78 to the reduction gearset 86 are contemplated.

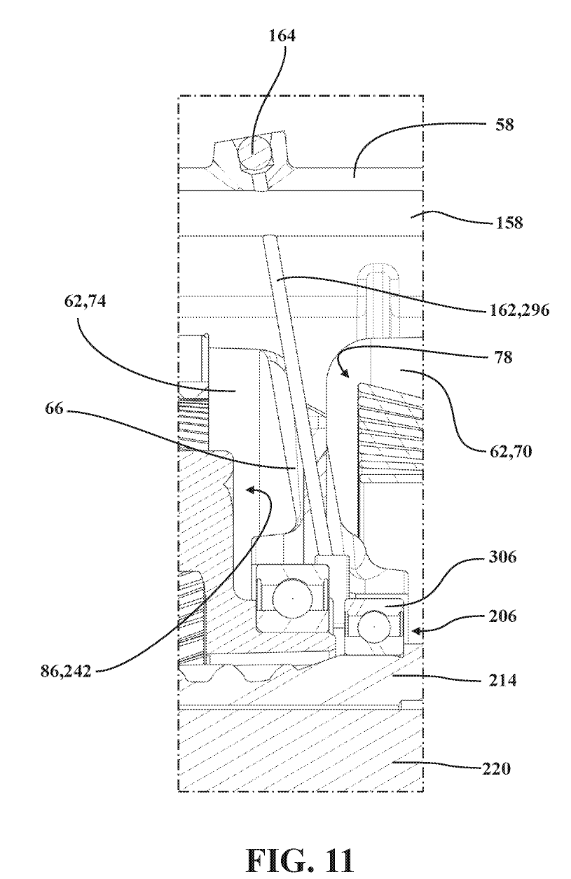

As best shown in FIGS. 9 and 11, in configurations where the rotor shaft 214 extends through the central void 206 of the divider wall 66, the electric drive unit 50 may further include a divider bearing 306 disposed in the central void 206 of the divider wall 66 and arranged to support the second rotor shaft portion 214B for rotation about the first axis A1. In these configurations, the plurality of distribution channels 162 may further include the fifth distribution channel 296 extending from the main supply channel 158 through the divider wall 66 to arrange the main supply channel 158 in fluid communication with the central void 206 for directing the fluid from the main supply channel 158 toward the divider bearing 306. Stated differently, the fifth distribution channel 296 routes the fluid from the main supply channel 158 through the interior of the divider wall 66 to the central void 206 so that the fluid is delivered to the divider bearing 306 for lubrication and/or cooling of the divider bearing 306 supporting the second rotor shaft portion 214B. Other configurations for delivering the fluid toward the divider bearing 306 are contemplated without departing from the scope of the present disclosure.

As also described above, the electric drive unit 50 includes the differential assembly 82. The differential assembly 82 is generally configured to receive torque generated by the electric machine 78 (and provided to the differential assembly 82 via the reduction gearset 86) and to transmit that torque to respective half shafts 218 (shown in FIG. 4) while accommodating differential rotation of the half shafts 218 relative to one another. The configuration of the differential assembly 82 is not limited for the purposes of this disclosure. As best shown in FIGS. 4 and 9, in the illustrated configuration, the differential assembly 82 includes a pinion carrier 222 supported for rotation about the first axis A1. The illustrated differential assembly 82 also includes a first side gear 226 disposed in the pinion carrier 222 for rotation relative to the pinion carrier 222 about the first axis A1. The first side gear 226 is configured to be coupled (directly or indirectly through an intermediate component) to one of the half shafts 218. As best shown in FIG. 4, in some embodiments, the electric drive unit 50 further includes a link shaft 220 coupled to the first side gear 226. The link shaft 220 serves as an intermediate component for coupling the first side gear 226 to one of the half shafts 218. In these configurations, the rotor 190 may define a central bore 192 extending along the first axis A1, and the link shaft 220 typically extends from the first side gear 226 in the second direction D2 through the central bore 192 of the rotor 190. Here, the end of the link shaft 220 opposite the first side gear 226 is configured to be coupled to one of the half shafts 218. Other configurations for coupling the first side gear 226 to one of the half shafts 218 are contemplated.

The illustrated differential assembly 82 further includes a second side gear 230 disposed in the pinion carrier 222 opposite the first side gear 226 for rotation relative to the pinion carrier 222 about the first axis A1. The second side gear 230 is configured to be coupled (directly or indirectly through an intermediate component) to the other of the half shafts 218. The illustrated differential assembly 82 further includes a plurality of pinion gears 234 coupled to the pinion carrier 222 for rotation about a second axis A2 transverse to the first axis A1. For example, the plurality of pinion gears 234 may be coupled to the pinion carrier 222 via a pinion shaft 238 coupled to the pinion carrier 222 for rotation with the pinion carrier 222 about the first axis A1. Where included, the pinion shaft 238 extends along the second axis A2 and the plurality of pinion gears 234 are coupled to the pinion shaft 238 for rotation about the second axis A2. Each pinion gear 234 is meshed with the first side gear 226 and the second side gear 230. The plurality of pinion gears 234 permit the first side gear 226 and the second side gear 230 to rotate at different angular speeds relative to one another. Thus, for example, when the vehicle including the electric drive unit 50 turns or one drive wheel experiences a traction difference, the plurality of pinion gears 234 rotate about the second axis A2 to accommodate the relative speed differential between the side gears 226, 230 while maintaining torque transfer to at least one of the side gears 226, 230.

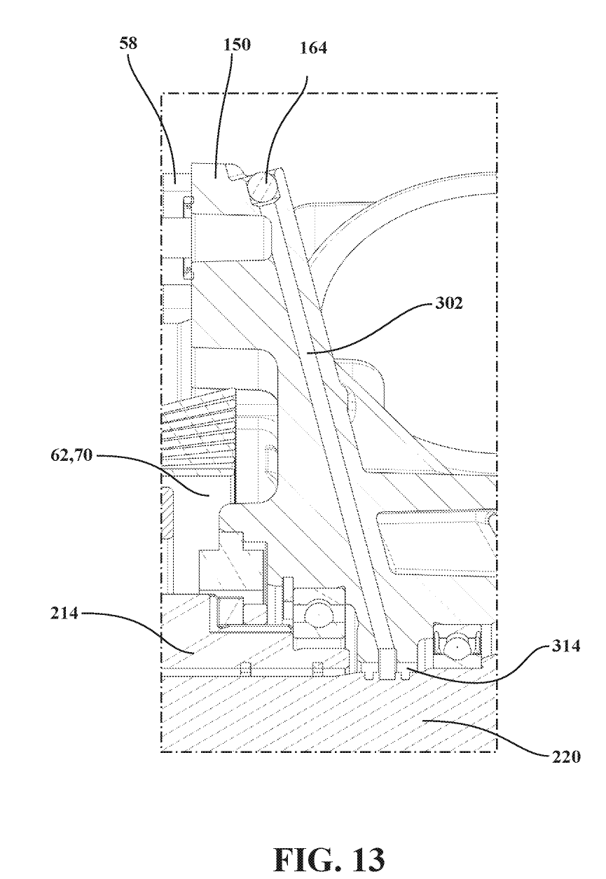

As shown throughout FIGS. 1-9, the housing assembly 54 typically further includes a first end cover 150 coupled to the first end 58A of the main housing body 58 to delimit the first chamber 70 in the second direction D2. In the illustrated configuration, the first end cover 150 is formed as a separate component that is removably coupled to the first end 58A of the main housing body 58; however, other configurations where the first end cover 150 is formed integrally or is otherwise permanently coupled with the first end 58A of the main housing body 58 (i.e., the first end cover 150 is not removable relative to the first end 58A of the main housing body 58) are contemplated. In configurations where the link shaft 220 is included, as best shown in FIGS. 4 and 13, the first end cover 150 defines a first end cover void 314 extending along the first axis A1, and the link shaft 220 extends in the second direction D2 through the first end cover void 314 toward the end of the link shaft 220 and is configured to be coupled to one of the half shafts 218. Other configurations of the first end cover 150 are contemplated without departing from the scope of the present disclosure.

With continued reference to FIG. 13, in configurations where the first end cover 150 defines the first end cover void 314, the first end cover 150 may further define a cover distribution channel 302 in fluid communication with the main supply channel 158 and extending through the first end cover 150 to the first end cover void 314 to arrange the main supply channel 158 in fluid communication with the first end cover void 314 for directing the fluid from the main supply channel 158 toward the link shaft 220. Stated differently, the cover distribution channel 302 routes the fluid from the main supply channel 158 through the interior of the first end cover 150 to the first end cover void 314, where the fluid is delivered toward the link shaft 220 for lubrication and/or cooling of the interface between the link shaft 220 and the first end cover 150. Other configurations of the cover distribution channel 302 are contemplated without departing from the scope of the present disclosure.

With continued reference to FIGS. 1-9, the housing assembly 54 typically further includes a second end cover 154 coupled to the second end 58B of the main housing body 58 to delimit the second chamber 74 in the first direction D1. In the illustrated configuration, the second end cover 154 is formed as a separate component that is removably coupled to the second end 58B of the main housing body 58; however, other configurations where the second end cover 154 is formed integrally or is otherwise permanently coupled with the second end 58B of the main housing body 58 are contemplated.

As also described above, the electric drive unit 50 includes the reduction gearset 86 for transmitting torque between the electric machine 78 and the differential assembly 82. The configuration of the reduction gearset 86 is not limited for the purposes of this disclosure. Exemplary configurations of the reduction gearset 86 include planetary gearsets, layshaft gearsets, countershaft gearsets, parallel axis gearsets, compound gearsets, and multi-stage reduction gearsets. Where the reduction gearset 86 includes planetary gearsets, the reduction gearset 86 may include a single-stage planetary gearset or multi-stage planetary gearsets. As best shown in FIGS. 4, 6 and 7, in the illustrated configuration, the reduction gearset 86 includes a first planetary gearset 242 and a second planetary gearset 246 arranged in series to constitute a two-stage planetary reduction gearset. In the illustrated embodiment, the reduction gearset 86 is disposed in the second chamber 74. However, it is to be appreciated that the reduction gearset 86 can alternatively be disposed in the first chamber 70.

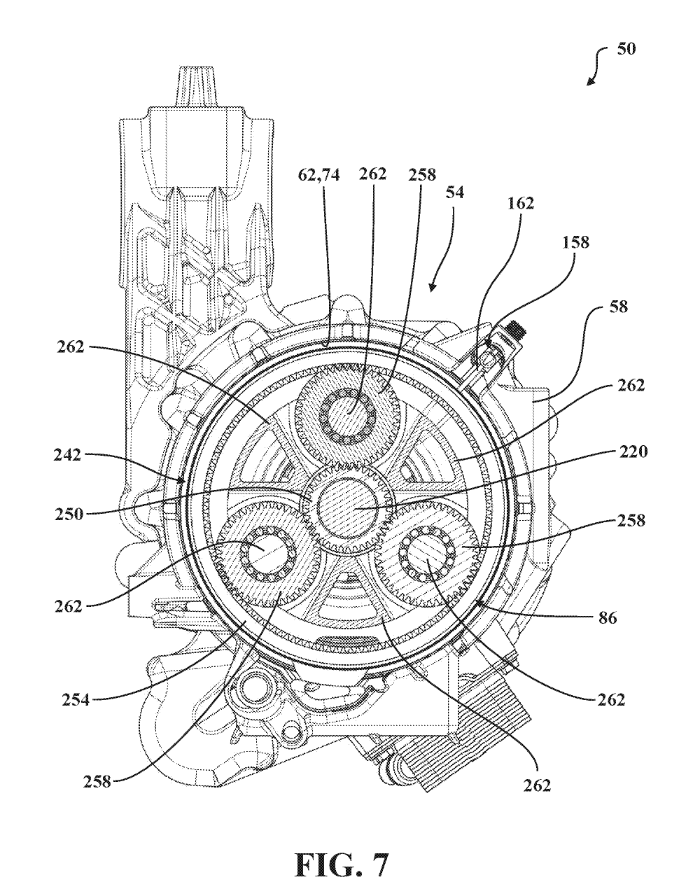

As best shown in FIG. 7, the first planetary gearset 242 includes a first sun gear 250. The first sun gear 250 is coupled to the electric machine 78 to transfer torque between the electric machine 78 and the reduction gearset 86. More specifically, the first sun gear 250 may be coupled to the second rotor shaft portion 214B for rotation with the rotor 190 about the first axis A1. In the illustrated configuration, the first sun gear 250 is integral with the second rotor shaft portion 214B, but configurations where the first sun gear 250 is a separate component coupled to the rotor shaft 214 are contemplated. The first planetary gearset 242 of the illustrated reduction gearset 86 also includes a first ring gear 254 fixed to the main housing body 58. The first ring gear 254 is typically fixed to the main housing body 58 such that the first ring gear 254 is rotationally constrained relative to the main housing body 58. For example, the first ring gear 254 may be welded or otherwise fastened to the main housing body 58. The first planetary gearset 242 of the illustrated reduction gearset 86 further includes a plurality of first planet gears 258 disposed between and meshed with the first sun gear 250 and the first ring gear 254. Accordingly, the plurality of first planet gears 258 are configured to orbit about the first axis A1 in response to rotation of the first sun gear 250. The first planetary gearset 242 of the illustrated reduction gearset 86 additionally includes a first planet carrier 262 coupled to the plurality of first planet gears 258. More specifically, the first planet carrier 262 maintains an angular spacing about the first axis A1 between each planet gear 258 of the plurality of first planet gears 258. Accordingly, the first planet carrier 262 rotates about the first axis A1 as the plurality of first planet gears 258 orbit about the first axis A1. In other words, during operation of the first planetary gearset 242, rotation of the first sun gear 250 at a first input speed causes the first planet gears 258 to orbit about the first axis A1, thereby driving rotation of the first planet carrier 262 about the first axis A1 at a first output speed less than the first input speed. The ratio of the first input speed to the first output speed defines the gear ratio of the first planetary gearset 242 of the illustrated reduction gearset 86.

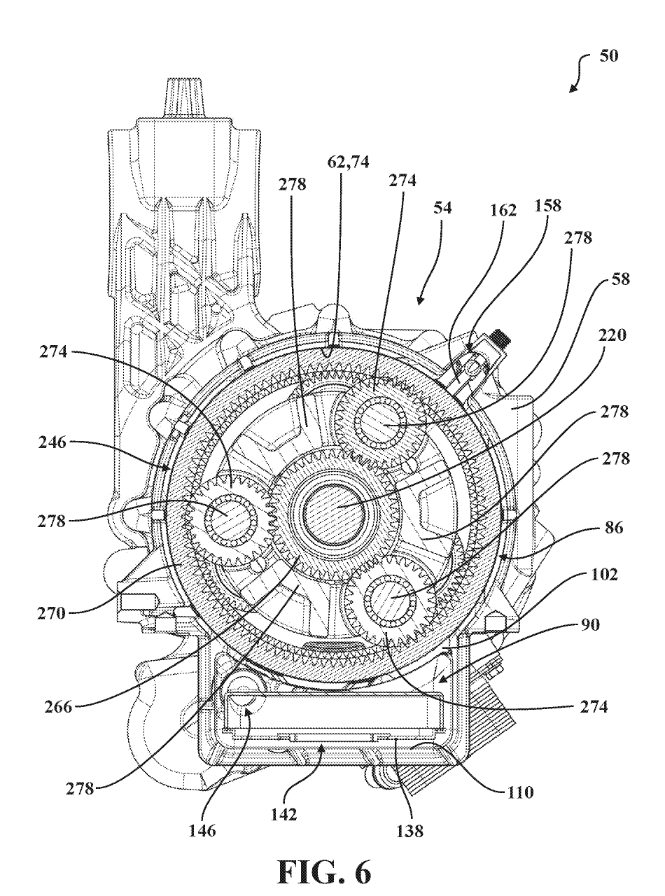

As best shown in FIG. 6, the second planetary gearset 246 of the illustrated reduction gearset 86 includes a second sun gear 266 coupled to the first planet carrier 262 for rotation with the first planet carrier 262 about the first axis A1. Stated differently, the output of the first planetary gearset 242 (i.e., the first planet carrier 262) is coupled to the input of the second planetary gearset 246 (i.e., the second sun gear 266) such that the first planetary gearset 242 and the second planetary gearset 246 are arranged in series. The second planetary gearset 246 of the illustrated reduction gearset 86 also includes a second ring gear 270 fixed to the main housing body 58. The second ring gear 270 is typically fixed to the main housing body 58 such that the second ring gear 270 is rotationally constrained relative to the main housing body 58. For example, the second ring gear 270 may be welded or otherwise fastened to the main housing body 58. The second planetary gearset 246 of the illustrated reduction gearset 86 further includes a plurality of second planet gears 274 disposed between and meshed with the second sun gear 266 and the second ring gear 270. Accordingly, the plurality of second planet gears 274 are configured to orbit about the first axis A1 in response to rotation of the second sun gear 266. The second planetary gearset 246 of the illustrated reduction gearset 86 additionally includes a second planet carrier 278 coupled to the plurality of second planet gears 274 and the differential assembly 82 to transmit torque between the reduction gearset 86 and the differential assembly 82. More specifically, the second planet carrier 278 maintains an angular spacing about the first axis A1 between each planet gear 274 of the plurality of second planet gears 274. Accordingly, the second planet carrier 278 rotates about the first axis A1 as the plurality of second planet gears 274 orbit about the first axis A1. In other words, during operation of the second planetary gearset 246, rotation of the second sun gear 266 at a second input speed causes the second planet gears 274 to orbit about the first axis A1, thereby driving rotation of the second planet carrier 278 about the first axis A1 at a second output speed less than the second input speed. The ratio of the second input speed to the second output speed defines the gear ratio of the second planetary gearset 246 of the illustrated reduction gearset 86. Cumulatively, the product of the gear ratio of the first planetary gearset 242 and the gear ratio of the second planetary gearset 246 defines the overall gear ratio of the reduction gearset 86. The reduction gearset 86 may have a gear ratio of 2:1 or greater, 5:1 or greater, 10:1 or greater, 15:1 or greater, 20:1 or greater, etc.

In the illustrated configuration, to transmit torque between the reduction gearset 86 and the differential assembly 82, the second planet carrier 278 of the second planetary gearset 246 is coupled to the pinion carrier 222 of the differential assembly 82 for rotation with the pinion carrier 222 about the first axis A1. Accordingly, the torque transmission path through the electric drive unit 50 extends from the electric machine 78 to the reduction gearset 86 and to the differential assembly 82. In other words, rotation generated by the rotor 190 is carried by the rotor shaft 214 to the first sun gear 250, transferred through the first planetary gearset 242 to the first planet carrier 262, passed from the first planet carrier 262 to the second sun gear 266, and then transferred through the second planetary gearset 246 to the second planet carrier 278 and ultimately to the pinion carrier 222 of the differential assembly 82. The differential assembly 82 then distributes the torque between the first side gear 226 and the second side gear 230. It should be appreciated that the configurations of the electric machine 78, the reduction gearset 86, and the differential assembly 82 illustrated and described herein are intended to serve as illustrative examples of suitable configurations of the electric machine 78, the reduction gearset 86, and the differential assembly 82 and the resulting torque transmission path therethrough, and that other configurations are contemplated.

Several embodiments have been described in the foregoing description. However, the embodiments described herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

Various additional alterations and changes beyond those already mentioned herein can be made to the above-described embodiments. This disclosure is presented for illustrative purposes and should not be interpreted as an exhaustive description of all embodiments or to limit the scope of the claims to the specific elements illustrated or described in connection with these embodiments. For example, and without limitation, any individual element(s) of the described embodiments may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Any reference to claim elements in the singular, for example, using the articles “a,” “an,” “the” or “said,” is not to be construed as limiting the element to the singular. It will be further appreciated that the terms “include,” “includes,” and “including” have the same meaning as the terms “comprise,” “comprises,” and “comprising.”

What is claimed is:

1. An electric drive unit comprising:
a housing assembly comprising a main housing body extending along a first axis between a first end and a second end spaced from said first end in a first direction along said first axis, wherein said main housing body defines a housing interior about said first axis and includes a divider wall that subdivides said housing interior into a first chamber extending along said first axis and delimited by said divider wall in said first direction and a second chamber extending along said first axis and delimited by said divider wall in a second direction opposite said first direction;
an electric machine disposed in said first chamber;
a differential assembly disposed in said second chamber; and
a reduction gearset coupled to said electric machine and said differential assembly for transmitting torque between said electric machine and said differential assembly;
wherein said main housing body further defines:
a main supply channel spaced radially from said first axis and extending parallel to said first axis, wherein said main supply channel is configured to receive fluid for distribution to said housing interior; and
a plurality of distribution channels including:
a first distribution channel extending between said main supply channel and said first chamber to arrange said main supply channel in fluid communication with said first chamber for directing the fluid from said main supply channel into said first chamber; and
a second distribution channel extending between said main supply channel and said second chamber to arrange said main supply channel in fluid communication with said second chamber for directing the fluid from said main supply channel into said second chamber.

2. The electric drive unit according to claim 1, wherein said first distribution channel has a first outlet having a first diameter and wherein said second distribution channel has a second outlet having a second diameter, wherein said first diameter and said second diameter are different.

3. The electric drive unit according to claim 1, wherein said second distribution channel is aligned with said differential assembly for directing the fluid from said main supply channel toward said differential assembly.

4. The electric drive unit according to claim 3, wherein said plurality of distribution channels further includes a third distribution channel spaced axially along said first axis from said second distribution channel and extending between said main supply channel and said second chamber to arrange said main supply channel in fluid communication with said second chamber.

5. The electric drive unit according to claim 4, wherein said reduction gearset is disposed in said second chamber and said third distribution channel is aligned with said reduction gearset for directing the fluid from said main supply channel toward said reduction gearset.

6. The electric drive unit according to claim 1, wherein said first distribution channel is aligned with said electric machine for directing the fluid from said main supply channel toward said electric machine.

7. The electric drive unit according to claim 6, wherein said plurality of distribution channels further includes a fourth distribution channel spaced axially along said first axis from said first distribution channel and extending between said main supply channel and said first chamber to arrange said main supply channel in fluid communication with said first chamber.

8. The electric drive unit according to claim 7, wherein said fourth distribution channel is aligned with said electric machine for directing the fluid from said main supply channel toward said electric machine.

9. The electric drive unit according to claim 1, wherein said electric machine comprises:
a stator coupled to said main housing body and disposed annularly about said first axis, said stator defining a stator bore; and
a rotor disposed in said stator bore for rotation relative to said stator about said first axis in response to energization of said stator.

10. The electric drive unit according to claim 9, wherein a stator fluid channel for receiving the fluid is defined between an outer circumference of said stator and said main housing body; and
wherein said first distribution channel is in fluid communication with said stator fluid channel for directing the fluid from said main supply channel to said stator fluid channel; and
wherein said stator fluid channel is in fluid communication with said first chamber for directing the fluid to said first chamber.

11. The electric drive unit according to claim 9, wherein said reduction gearset is disposed in said second chamber;
wherein said divider wall defines a central void extending along said first axis;
wherein said rotor comprises a rotor body disposed in said stator bore and a rotor shaft extending along said first axis between:
a first rotor shaft portion coupled to said rotor body such that said rotor shaft rotates with said rotor about said first axis in response to energization of said stator; and
a second rotor shaft portion extending from said first rotor shaft portion in said first direction through said central void of said divider wall, said second rotor shaft portion coupled to said reduction gearset to transmit torque between said electric machine and said differential assembly.

12. The electric drive unit according to claim 11 further comprising a divider bearing disposed in said central void of said divider wall and arranged to support said second rotor shaft portion for rotation about said first axis; and
wherein said plurality of distribution channels further includes a fifth distribution channel extending from said main supply channel through said divider wall to arrange said main supply channel in fluid communication with said central void for directing the fluid from said main supply channel toward said divider bearing.

13. The electric drive unit according to claim 1, wherein said differential assembly comprises:
a pinion carrier supported for rotation about said first axis;
a first side gear disposed in said pinion carrier for rotation relative to said pinion carrier about said first axis;
a second side gear disposed in said pinion carrier opposite said first side gear for rotation relative to said pinion carrier about said first axis; and
a plurality of pinion gears coupled to said pinion carrier for rotation about a second axis transverse to said first axis, each of said plurality of pinion gears meshed with said first side gear and said second side gear to transfer torque from said pinion carrier to said first side gear and said second side gear.

14. The electric drive unit according to claim 13, wherein said electric machine includes a rotor defining a central bore extending along said first axis; and
wherein said electric drive unit further comprises a link shaft coupled to said first side gear and extending from said first side gear in said second direction along said first axis through said central bore of said rotor.

15. The electric drive unit according to claim 14, wherein said housing assembly further comprises a first end cover coupled to said first end of said main housing body to delimit said first chamber in said second direction;
wherein said first end cover defines a first end cover void extending along said first axis, and said link shaft extends in said second direction through said first end cover void.

16. The electric drive unit according to claim 15, wherein said first end cover defines a cover distribution channel in fluid communication with said main supply channel and extending through said first end cover to said first end cover void to arrange said main supply channel in fluid communication with said first end cover void for directing the fluid from said main supply channel toward said link shaft.

17. The electric drive unit according to claim 1, wherein said main housing body further defines a fluid sump in fluid communication with said housing interior and said electric drive unit further comprises a fluid pump in communication with said fluid sump and said main supply channel for directing the fluid from said fluid sump into said main supply channel.

18. The electric drive unit according to claim 17, wherein said fluid sump is spaced radially outward relative to said first axis from said first chamber and said second chamber; and
wherein said main housing body further defines:
a first drain path extending between said first chamber and said fluid sump to arrange said first chamber in fluid communication with said fluid sump for returning the fluid from said first chamber to said fluid sump; and
a second drain path extending between said second chamber and said fluid sump to arrange said second chamber in fluid communication with said fluid sump for returning the fluid from said second chamber to said fluid sump.

19. The electric drive unit according to claim 17, wherein said main housing body includes a radial extension and a lower sump wall extending axially relative to the radial extension to define said fluid sump.

20. The electric drive unit according to claim 1, wherein said reduction gearset comprises:
a first planetary gearset comprising:
a first sun gear coupled to said electric machine to transmit torque between said reduction gearset and said electric machine;
a first ring gear fixed to said main housing body;
a plurality of first planet gears disposed between and meshed with said first sun gear and said first ring gear such that said plurality of first planet gears orbit about said first axis in response to rotation of said first sun gear; and
a first planet carrier coupled to said plurality of first planet gears such that said first planet carrier rotates about said first axis in response to rotation of said first sun gear; and
a second planetary gearset comprising:
a second sun gear coupled to said first planet carrier for rotation with said first planet carrier about said first axis;
a second ring gear fixed to said main housing body;
a plurality of second planet gears disposed between and meshed with said second sun gear and said second ring gear such that said plurality of second planet gears orbit about said first axis in response to rotation of said second sun gear; and
a second planet carrier coupled to said plurality of second planet gears and said differential assembly to transmit torque between said reduction gearset and said differential assembly.
